(19) United States
(12) Patent Application Publication
(10) Pub. No.: US 2024/0017281 A1
(43) Pub. Date: Jan. 18, 2024

(54) COATING DEVICE COMPRISING A VIBRATION SENSOR, AND CORRESPONDING OPERATING METHOD

(71) Applicant: Dürr Systems AG, Bietigheim-Bissingen (DE)

(72) Inventors: Bernhard Seiz, Lauffen (DE); Harry Krumma, Bönnigheim (DE); Hans-Jürgen Nolte, Besigheim (DE); Christoph Heckeler, Renningen (DE)

(21) Appl. No.: 18/255,189

(22) PCT Filed: Nov. 8, 2021
(86) PCT No.: PCT/EP2021/080932

§ 371 Date: May 31, 2023

(30) Foreign Application Priority Data
Dec. 10, 2020 (DE) 10 2020 132 932.6

(51) Int. Cl. B05B 12/00; B05B 13/04; B25J 9/16

(52) U.S. Cl. CPC B05B 12/004; B05B 13/0431; B25J 9/1674; G01M 13/028

(57) ABSTRACT

The disclosure relates to a coating device having a plurality of components which are susceptible to malfunctions, a vibration sensor for detecting mechanical vibrations in the coating device and for converting them into a vibration signal which can be evaluated by control technology, and having an evaluation unit for evaluating the vibration signal from the vibration sensor and for diagnosing an operating malfunction in one of the components of the coating device which are susceptible to malfunctions as a function of the vibration signal. The disclosure provides that the evaluation unit diagnoses various operational malfunctions of various malfunction-prone components of the coating device by evaluating the vibration signal of the vibration sensor.

### CROSS-REFERENCE TO RELATED APPLICATIONS

This application is a national stage of, and claims priority to, Patent Cooperation Treaty Application No. PCT/EP2021/080932, filed on Nov. 8, 2021, which application claims priority to German Application No. DE 10 2020 132 932.6, filed on Dec. 10, 2020, which applications are hereby incorporated herein by reference in their entireties.

### TECHNICAL FIELD

The disclosure relates to a coating device (e.g. painting robot) for coating components (e.g. motor vehicle body components) with a coating agent (e.g. paint). Furthermore, the disclosure relates to a corresponding operating method.

### BACKGROUND

In modern painting installations for painting motor vehicle body components, rotary atomizers are usually used as application device, rotating a bell cup at high speed, whereby the paint to be applied is spun off and atomized by the rotating bell cup.

During operation, however, an imbalance can occur in the rotary atomizer, which can lead to a malfunction. Such an imbalance can occur, for example, if there is a collision between the bell cup and a room boundary (e.g., booth wall of the paint booth). Such operational disturbances of the rotary atomizer should be detected during operation so that the operational malfunction can be corrected without severely affecting the operation of the paint booth.

From WO 2016/180521 A1, a painting installation is known that detects such operating malfunctions of rotary atomizers. For this purpose, vibration sensors are used to analyze the mechanical vibrations emanating from the rotary atomizer and thereby detect an operating malfunction.

However, the disadvantage of this known concept is the fact that the evaluation of the vibration signals from the various vibration sensors only allows conclusions to be drawn about a specific operating malfunction of the rotary atomizer. With this known concept, on the other hand, it is not possible to detect and localize operating malfunctions in other components of the painting installation that are susceptible to malfunctions. Furthermore, with this known concept, it is not possible to distinguish between different types of operating malfunctions.

Finally, the technical background of the disclosure is also described in US 2019/0 314 842 A1.

### BRIEF DESCRIPTION OF THE DRAWINGS

FIG. 1 shows a schematic representation of a painting robot according to the disclosure with a rotary atomizer, whereby a vibration analysis enables the detection of operating malfunctions.

FIG. 2 shows a perspective view of the painting robot.

FIG. 3 shows a schematic representation for the calculation of a vibration characteristic value by sensor electronics in the vibration sensor.

FIG. 4 shows a schematic diagram for the calculation of the vibration characteristic value by a microprocessor in the evaluation unit.

FIG. 5 shows a diagram illustrating the vibration behavior in the case of an unbalance of a rotary atomizer.

FIG. 6 shows a diagram illustrating the vibration behavior of a rotary atomizer after a collision.

FIG. 7 shows a flow chart to illustrate the operating method according to the disclosure.

FIG. 8 shows a variation of the flow chart according to FIG. 7.

FIG. 9 shows a modification of the flow chart according to FIG. 6 to illustrate a vibration event in a valve circuit of a valve.

FIG. 10 shows a flow diagram to explain a variant of the operating method according to the disclosure.

FIG. 11 shows a flow chart of a further variant of the operating method according to the disclosure, in which it is possible to switch specifically to a measuring process in order to facilitate diagnosis of the operating malfunctions.

### DETAILED DESCRIPTION

The coating device according to the disclosure is preferably used for coating motor vehicle body components with a paint. However, the disclosure is not limited to this particular field of application with respect to the type of components to be coated and the type of coating agent applied. For example, the coating device according to the disclosure can also apply other coating agents, such as insulating materials, sealants, or adhesives, to name just a few examples. There are also no limitations within the scope of the disclosure with regard to the type of components coated. Instead of motor vehicle body components, the coating device according to the disclosure can also be designed for coating other components. Exemplary components are aircraft components or components of wind turbines.

In a preferred embodiment of the disclosure, however, the coating device is a painting robot as is known per se from the prior art, so that a detailed description of the constructional details of the painting robot can be dispensed with here.

The coating device according to the disclosure has, in accordance with the above-mentioned known coating device, several components which are susceptible to malfunction and in which operating malfunctions can occur during operation of the coating device. It was merely mentioned above that operational malfunctions can occur at a rotary atomizer, whereby these operational malfunctions are generated by an imbalance. However, the concept of a component susceptible to malfunction is to be understood generally within the scope of the disclosure and is not limited to rotary atomizers. Rather, within the scope of the disclosure, operational malfunctions can also occur in other components, as will be explained in detail later.

In addition, the coating device according to the disclosure also has at least one vibration sensor, in accordance with the known painting installation described at the beginning, in order to detect mechanical vibrations in the coating device and to generate a vibration signal which can be evaluated in terms of control technology and which reproduces the mechanical vibrations.

Furthermore, the coating device according to the disclosure also has, in accordance with the known coating device described at the beginning, an evaluation unit which serves to evaluate the vibration signal emanating from the vibration sensor and, as a function thereof, to diagnose an operating malfunction in one of the components of the coating device which are susceptible to malfunctions.

The coating device according to the disclosure is characterized by the fact that the evaluation unit not only detects an operating malfunction, but also diagnoses various operating malfunctions of different malfunction-prone components by evaluating the vibration signal.

On the one hand, the evaluation unit can thus distinguish between different types of operating malfunctions by evaluating the vibration signal, which is not possible in the prior art.

On the other hand, the evaluation unit can also distinguish operating malfunctions of different components that are susceptible to malfunctions. For example, by evaluating the vibration signal, the evaluation unit can distinguish whether there is an imbalance of a bell cup or a bearing damage on the painting robot.

It has already been briefly mentioned above that, within the scope of the disclosure, various components of the coating device that are susceptible to malfunction can be monitored for operating malfunctions, i.e. not only rotary atomizers, as is known per se from the prior art.

For example, the malfunction-prone component that is monitored for operational malfunctions may be a coating robot (e.g., painting robot), which as such has multiple robot axes. Typically, such coating robots have serial robot kinematics and at least six robot axes, as is known per se from the prior art. In the preferred embodiment of the disclosure, the coating robot has a robot base, a pivotable robot member, a proximal robot arm, a distal robot arm, and/or a robot hand axis. Various operational malfunctions can occur on such a coating robot, such as bearing damage, gearbox damage, or motor damage.

Further, the malfunction-prone component that is monitored for an operational malfunction may be an application device that is used to apply the coating agent. As an example of such an application device, a rotary atomizer has already been mentioned above. Within the scope of the disclosure, however, other types of application devices can also be monitored for an operating malfunction, such as, for example, so-called print heads which apply the coating to be applied essentially without overspray.

Another component that is susceptible to malfunction and can be monitored for malfunction during operation is a compressed-air turbine, which can be used, for example, in a rotary atomizer to rotate a turbine shaft, as is known per se from the prior art. In such compressed-air turbines, a bearing damage, for example, can occur as an operating malfunction.

It has already been briefly mentioned above that, in the case of a rotary atomizer, a collision between the bell cup and a room boundary (e.g., cabin wall of the paint booth) can lead to an imbalance. Thus, the component susceptible to malfunction, which is monitored for malfunction during operation, may also be a bell cup.

Furthermore, it is possible within the scope of the disclosure to detect operating malfunctions of a metering pump that meters the coating agent to the application device.

Furthermore, it has already been briefly mentioned above that conventional coating robots have motors, gearboxes and bearings which can also exhibit operating malfunctions which can be diagnosed within the scope of the disclosure. Thus, the components susceptible to malfunction that are monitored for operational malfunction within the scope of the disclosure may also be motors, gearboxes, and/or bearings of the coating robot.

Finally, coating devices typically include controllable pressure valves, such as a coating agent valve for controlling the flow of coating agent or a rinsing agent valve for controlling the flow of rinsing agent. Such pressure valves can also exhibit operational malfunctions during operation. The component that is susceptible to malfunction and is monitored during operation for an operational malfunction can therefore also be a controllable pressure valve, for example in a rotary atomizer. In general, the monitored component of the coating device can also be any valve, for example electrically controlled.

The foregoing description of various components susceptible to malfunction is not exhaustive. Rather, the concept according to the disclosure can also be used to detect operating malfunctions in other components of a coating device.

It has already been mentioned above that the concept according to the disclosure is preferably suitable for detecting malfunctions on a coating robot (e.g. painting robot) which guides an applicator (e.g. rotary atomizer). Here, it is possible to detect operating malfunctions of the applicator by evaluating the vibration signal of the vibration sensor. The vibration sensor can be mounted on the coating robot at a distance from the application device. The mechanical vibrations emitted by the application device are transmitted via the coating robot to the vibration sensor, whereby the coating robot has certain vibration transmission properties. The evaluation unit can then evaluate the vibration signal from the vibration sensor, taking into account the vibration transmission properties of the coating robot. For example, the vibration sensor can be mounted on the robot base, on a rotatable robot member, on the proximal robot arm (“Arm 1”), on the distal robot arm (“Arm 2”), or on the robot hand axis, to name just a few examples.

The spatial separation between the application device to be monitored on the one hand and the vibration sensor on the other hand is technically advantageous in particular if the coating robot has an electrostatic coating agent charging system. In this case, the application device is located in a high-voltage area, so that the arrangement of the vibration sensor directly on or in the application device would be problematic because the vibration sensor would then also be at high-voltage potential. In contrast, the spatial separation between the application device to be monitored on the one hand and the vibration sensor on the other hand offers the possibility that the vibration sensor is arranged in the electrically grounded area, so that the interrogation of the vibration sensor is much easier, since no potential separation is required for this.

It has already been briefly mentioned above that the concept according to the disclosure offers the possibility of diagnosing and distinguishing between various operating malfunctions of the coating device.

One possible operational malfunction is—as already briefly mentioned above—an imbalance of a bell cup of a rotary atomizer. However, such an unbalance can occur not only at the bell cup, but also at other rotating components that rotate with the bell cup, such as the turbine shaft of the rotary atomizer.

Another possible malfunction is therefore an imbalance in a component of the rotary atomizer that rotates with the bell cup.

Another possible malfunction is mechanical wear of a bearing (e.g. rolling bearing), for example a bearing of the rotary atomizer or a bearing of the coating robot. The bearing can be any bearing, for example on a gearbox, an axis or a motor, to name just a few examples.

Other possible operational malfunctions that can be detected during operation include a loss of oil on a gearbox, missing gearbox oil, or a loss of oil or missing motor oil on a motor of the coating robot. Such operational malfunctions result in increased friction, which causes measurable vibration.

Furthermore, assembly malfunctions can also be detected within the scope of the disclosure, such as an incorrect tightening torque of a fastening screw or incorrect assembly of a drive shaft.

In addition, an operating malfunction may also consist in the fact that a drive shaft of a metering pump is incorrectly mounted or is not structurally suitable.

Finally, within the scope of the disclosure, there is also the possibility that collisions of the coating robot with an obstacle are detected, for example, with a room boundary (e.g., a booth wall of a painting booth) or with another coating robot.

The above description of various possible operational malfunctions is not exhaustive. Rather, the concept according to the disclosure also enables the detection of other operating malfunctions which are reflected in a change of the vibration behavior.

With regard to the design and the mode of operation of the vibration sensor, various possibilities exist within the scope of the disclosure. For example, the vibration sensor can be a two-axis or three-axis acceleration sensor. Alternatively, there is also the possibility that the acceleration sensor is a two-axis or three-axis acceleration sensor that also comprises a two-axis or three-axis gyroscope. Thus, the disclosure is not limited to certain types of vibration sensors with respect to the design and operation of the vibration sensor.

It has already been briefly mentioned above that coating devices usually have an electrostatic coating agent charging system, so that the coating device has a high-voltage area and an electrically grounded area. The vibration sensor is then preferably arranged in the electrically grounded area, which simplifies the interrogation of the vibration sensor since no potential separation is required.

Furthermore, it should be mentioned that painting facilities often also have an explosion-proof chamber, which may for example have an air purging system. Such explosion-proof rooms are described, for example, in the technical standards IEC/EN 60079-11-Part 11, IEC/EN 60079-25-Part 25 and IEC/EN 60079-14-Part 14. The vibration sensor can be located either in the explosion-proof chamber or outside the explosion-proof chamber.

With regard to the spatial arrangement of the vibration sensor in a coating robot, it should also be mentioned that such coating robots each have an axis drive with a housing for the individual robot axes. The vibration sensor can, for example, be arranged in the housing of the axis drive for the fourth, fifth or sixth robot axis.

It has already been mentioned above that the evaluation unit evaluates the vibration signal supplied by the vibration sensor in order to be able to detect operating malfunctions in the coating device. Here it is also possible that first a vibration characteristic value is calculated from the vibration signal, whereby the evaluation unit then carries out the analysis on the basis of this vibration characteristic value. The vibration characteristic value can be, for example, the effective value of the vibration signal, the maximum value of the vibration signal, the first-order amplitude of the vibration signal, a higher-order amplitude of the vibration signal, the distortion factor of the vibration signal or the crest factor of the vibration signal, to name just a few examples.

In one variant of the disclosure, the vibration characteristic value is calculated directly in the vibration sensor by sensor electronics integrated in the vibration sensor.

In another variant of the disclosure, on the other hand, the vibration characteristic value is first calculated from the vibration signal in the evaluation unit, the evaluation unit preferably being structurally separate from the vibration sensor. Alternatively, however, it is also possible for the evaluation unit to be structurally integrated into the vibration sensor or to form a structural unit with the vibration sensor by arranging the evaluation unit directly on the vibration sensor.

If the vibration sensor and the evaluation unit are spatially separated, it is also possible for the evaluation unit to consist of several spatially separated parts, such as an evaluation unit on the coating robot and a robot control unit.

In general, part of the evaluation can also be performed directly at the vibration sensor, while another part of the evaluation is performed in the spatially separated evaluation unit. For example, the individual signals can be filtered and superimposed to form an overall signal directly at the vibration sensor, while the vibration characteristic value is calculated from the overall signal in the spatially separate evaluation unit.

In principle, the comparison of the vibration characteristic value or the vibration characteristic values with one or more limit value(s) can also be carried out directly at the sensor, in the spatially separated evaluation unit or partly directly at the sensor and partly in the spatially separated evaluation unit.

Furthermore, within the scope of the disclosure, it is also possible that the vibration characteristic value is calculated by software running in a microprocessor connected to the evaluation unit or integrated in the evaluation unit.

During the evaluation of the vibration characteristic value, the vibration characteristic value can, for example, be compared with a limit value (e.g. maximum value), whereby a first warning signal is generated if the vibration characteristic value exceeds the limit value. The first warning signal can then, for example, be displayed visually and/or acoustically to the operator of the coating device. Alternatively, however, it is also possible that the first warning signal is merely an error flag in a machine control system.

Furthermore, within the scope of the disclosure, it is possible for the evaluation unit to monitor the vibration characteristic value over the operating period of the coating device. The evaluation unit can then compare the vibration characteristic value with a predetermined component-specific aging behavior and generate a second warning signal if the comparison of the vibration characteristic value with the predetermined aging behavior indicates that maintenance or replacement of a malfunction-prone component is required due to wear. Thus, the second warning signal can be a maintenance signal indicating to the operator that maintenance is due. However, the second warning signal may also be a stop signal indicating to the operator that operation must be interrupted, and the stop signal may also automatically cause operation to stop.

In addition, it should be mentioned that the frequency spectrum can also be determined as part of the evaluation of the vibration signal (e.g., to evaluate the 1st order and/or higher order amplitudes). Several different total signals can also be used to calculate one or more vibration characteristic values, e.g. calculation of several vibration characteristic values from different total signals, use of several different total signals to calculate one vibration characteristic value.

Furthermore, it is possible to calculate several vibration parameters from several individual signals, e.g. from all individual signals or only from selected individual signals.

It has already been mentioned above that the evaluation unit monitors the vibration behavior of the components susceptible to malfunction. This vibration monitoring can be carried out, for example, during normal operation of the coating device. However, it is alternatively also possible that the vibration analysis takes place in a specific measuring process outside the normal coating operation. For this purpose, a control unit can be provided which controls the coating device according to a predetermined measuring process. The vibration sensor then detects the vibrations in the coating device during the measuring process, and the evaluation unit evaluates the detected vibration signals to detect operating malfunctions.

For example, the control unit can control the coating robot to a specific robot position for vibration measurement during the measurement process, which enables or simplifies meaningful vibration analysis.

Furthermore, it is possible within the scope of the disclosure for the control unit to control the rotary atomizer for vibration measurement during the measurement process at a specific rotational speed that is not in the range of resonance frequencies.

Alternatively, however, it is also possible for the control unit to specifically drive the rotational atomizer for vibration measurement during the measurement process at a rotational speed that matches a resonance frequency.

In addition, the control unit can also control the rotary atomizer for vibration measurement during the measurement process successively with increasing rotational speeds, whereby a vibration measurement is carried out in each case at the individual rotational speeds. Furthermore, within the scope of the disclosure, it is possible for the control unit to control the rotary atomizer during the measuring process at different speeds that run through a predefined speed band. The evaluation unit can then determine actual values of the natural frequencies of the malfunction-prone component within the speed band during the measuring process and compare the determined actual values with predetermined target values of the natural frequencies in order to detect an operating malfunction.

It should also be mentioned that, within the scope of the disclosure, a single vibration sensor may be sufficient to detect and distinguish between different operating malfunctions on different components of the coating device that are susceptible to malfunctions. However, it is alternatively possible within the scope of the disclosure for the coating device to have multiple vibration sensors.

In principle, evaluations of vibration signals in the time domain and/or in the frequency domain are conceivable within the scope of the disclosure. For monitoring, in addition to the “intensity” of a vibration event (e.g. in the form of vibration characteristics such as amplitudes, rms values, etc.), its temporal characteristics (e.g. temporal duration, transient or periodic) on the one hand and/or its frequency characteristics on the other hand (e.g. contained frequency components, frequency-related “intensities”) can be taken into account.

Further it is to be mentioned that the coating device (e.g. painting installation) makes different procedures possible for the identification of errors or malfunctions, which are described in the following briefly.
Procedure 1: The coating device (e.g. painting installation) works in the normal process mode, i.e. it can be many or all parts of the plant at the same time in enterprise/active. The vibration signal therefore basically contains a large number of vibration information from different sources (e.g. atomizers, motors, gearboxes, valves, axes, . . . ). The vibration sensor “listens” to all possible malfunctions at the same time and analyzes/recognizes errors by an “intelligent” evaluation, quasi by “isolating” individual errors from the plurality of vibration information on the basis of suitable evaluation.
Procedure 2: The coating device (e.g. painting plant) is operated specifically in certain measuring procedures, whereby only individual parts of the plant are active (e.g. certain turbine speed with stationary robot, defined movement of an axis with not rotating turbine, switching of certain valves with stationary plant or the like more). The vibration signal is therefore dominated by the vibration information that can be assigned precisely to this specific measurement procedure, i.e. the evaluation is carried out specifically on the basis of this vibration information.

The “Procedure 2” described above can be carried out as a follow-up investigation if no clear result was initially found from the “Procedure 1” described above with regard to the malfunction/error.

However, the “Procedure 2” described above can also be carried out as the only procedure alternatively to the “Procedure 1” described above.

Furthermore, redundant monitoring is possible within the scope of the disclosure: For the evaluation of malfunctions, the vibration evaluation can be combined with results from other evaluations, e.g. from other sensors (pressure, current, voltage, speed, torques, force, . . . ). In practice, the coating device (e.g. painting installation, robot) usually provides a lot of analyses, sensor results, which can all be taken into account in the redundant monitoring. Several vibration sensors in this context at different locations are also conceivable.

Furthermore, Artificial Intelligence (AI) can also be used in the context of the analysis to derive evaluations from the totality of these many different signals.

Furthermore, the disclosure enables a comparison of several robots among each other within a robot cell, within a painting line or within a painting installation. In this way, it is then possible to identify robots that are particularly susceptible to malfunctions (“black sheep”).

Furthermore, the disclosure is also suitable for so-called “predictive maintenance”, whereby maintenance measures are initiated as a function of the evaluation of the vibration signals, i.e. independently of fixed maintenance intervals. Even a supposedly positive change in the vibration behavior (e.g. reduction of a vibration characteristic value compared to a previous measurement) can indicate an unfavorable development, e.g. in the sense of wear/aging processes. In this case the change itself is of interest, no matter in which direction. This is then evaluated e.g. by an “artificial intelligence”. Generally speaking, for an evaluation both the (absolute) vibration characteristics and the associated limit values (e.g. vibration intensity due to unbalance) as well as (relative) changes of the vibration behavior or the vibration characteristics (e.g. over time, compared to previous measurements, . . . ) can be taken into account.

Furthermore, it should be mentioned that the disclosure does not only claim protection for the coating device described above. Rather, the disclosure also claims protection for a corresponding operating method. The individual process steps of the operating method according to the disclosure are already apparent from the above description, so that a separate description of the individual process steps can be dispensed with.

Other advantageous further embodiments of the disclosure are indicated in the dependent claims or are explained in more detail below together with the description of the preferred embodiments of the disclosure with reference to the figures.

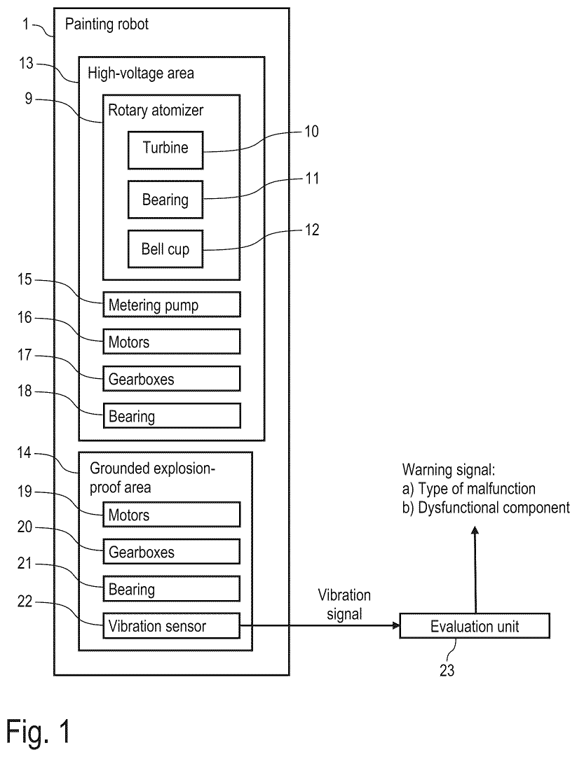

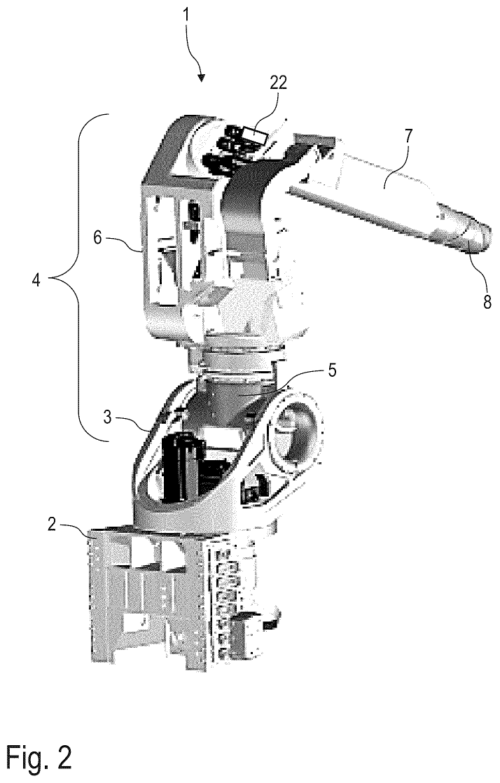

FIGS. 1 and 2 show various representations of a painting robot 1 according to the disclosure, which is largely of conventional design. Thus, the painting robot 1 initially has a stationary robot base 2, which supports a rotatable robot member 3, which in this embodiment is rotatable about a vertical axis of rotation. It should be mentioned here that the painting robot 1 can alternatively also have a movable robot base, so that the painting robot 1 can be moved along a traversing rail. The rotatable robot member 3 again carries a proximal robot arm 4, which is also referred to as “arm 1” according to the usual technical terminology in the field of robotics. The proximal robot arm 4 is here divided into two arm parts 5, 6, which are rotatable relative to each other. The proximal robot arm 4 in turn carries a distal robot arm 7, wherein a multi-axis robotic hand axis 8 is mounted at the end of the distal robot arm 7. The robot hand axis 8 in turn carries a rotary atomizer 9 as an application device, whereby the rotary atomizer 9 is not shown in FIG. 2 for simplification.

The rotary atomizer 9 can be of largely conventional design and contains a compressed air turbine 10 with a bearing 11, the compressed air turbine 10 rotating a bell cup 12 during operation.

In a conventional manner, the painting robot 1 has an electrostatic coating agent charging system and thus includes a high voltage area 13 and a grounded, explosion-proof area 14.

In the high-voltage area 13 of the painting robot 1, in addition to the rotary atomizer 9, there is also a metering pump 15 as well as motors 16, gearboxes 17 and bearings 18 of the painting robot 1.

Motors 19, gearboxes 20 and bearings 21 of the painting robot 1 are also located in the electrically grounded area 14.

Furthermore, the painting robot 1 contains valves, for example in the rotary atomizer 9 and in the metering pump 15, although these valves are not shown for simplicity. Malfunctions of these valves can also be detected within the scope of the disclosure.

Furthermore, a vibration sensor 22 is also located in the electrically grounded area 14, which detects mechanical vibrations of the aforementioned components of the painting robot 1 and generates a corresponding vibration signal, which is forwarded to an evaluation unit 23. The evaluation unit 23 then analyzes the vibration signal to detect operational malfunctions.

In one aspect, the evaluation unit 23 can thereby identify the component that has malfunctioned. Thus, by analyzing the vibration signal, the evaluation unit 23 can distinguish whether one of the motors 16 in the high-voltage area 13 is disturbed or one of the motors 19 in the electrically grounded area 14, to give just one example.

On the other hand, however, the evaluation unit 23 can also identify the type of operational malfunction by the vibration analysis. Thus, the evaluation unit 23 can distinguish different types of operating malfunctions from each other.

In this embodiment, the vibration sensor 22 is arranged in the distal robot arm 7. Alternatively, however, it is also possible, for example, for the vibration sensor 22 to be arranged in the proximal robot arm 4, in the rotatable robot member 3 or in the robot base 2. However, as the distance between the rotary atomizer 9 and the vibration sensor 22 increases, it becomes increasingly difficult to conclude possible operating malfunctions of the rotary atomizer 9 by evaluating the vibration signal. This is due to the vibration transmission behavior within the painting robot 1 and also to the damping of the mechanical vibrations on the way from the rotary atomizer 9 to the vibration sensor 22. The vibration sensor 22 should therefore not be mounted too far away from the rotary atomizer 9 in order not to make signal evaluation more difficult. However, the vibration sensor 22 is arranged centrally so that vibration events from differently located components, such as robot arms, members or the rotary atomizer 9, can be detected centrally. Advantageously, the good transmission properties of the robot arms are exploited.

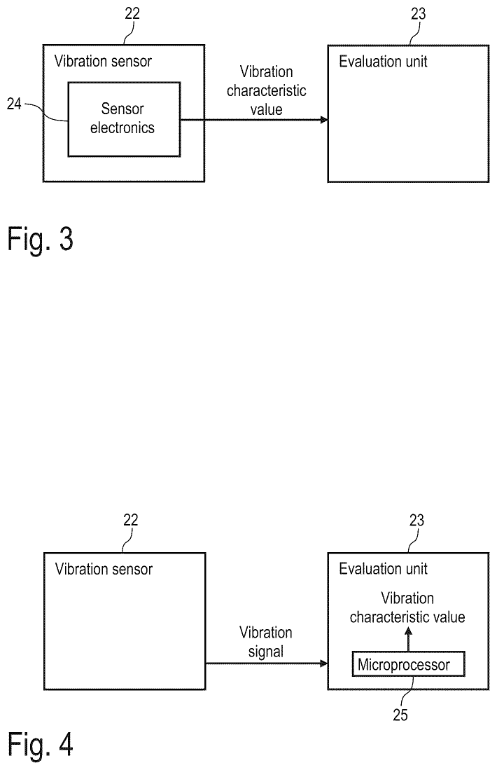

FIG. 3 shows a schematic diagram to illustrate the signal evaluation of the vibration sensor 22. Here, sensor electronics 24 are integrated in the vibration sensor 22, which calculate a vibration characteristic value from the vibration signal, such as the effective value, the distortion factor or the crest factor of the vibration signal. For this purpose, the time-related vibration signal is first decomposed into frequency components, for example by means of a fast Fourier transformation, and filtered if necessary. This vibration characteristic value is then forwarded to the evaluation unit 23 for signal evaluation.

FIG. 4 shows a modification of FIG. 3, in which the vibration characteristic value is calculated by a microprocessor 25 which is integrated in the evaluation unit 23.

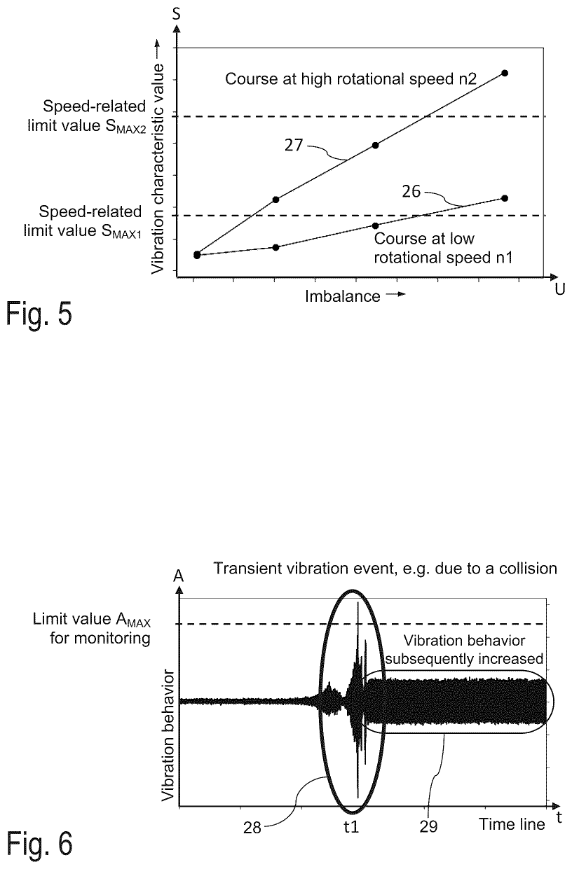

FIG. 5 is a diagram illustrating the measurable intensity of the vibration characteristic due to an unbalance U on a rotary atomizer, where the unbalance U may increase during operation, for example due to collisions of the rotary atomizer 9 with a room boundary (e.g. booth wall of the paint booth) and also due to normal component wear. More generally, however, the unbalance could also decrease for some reason.

A first characteristic curve 26 shows the increase of the unbalance U at a relatively low speed n1 of the rotary atomizer 9. At this low speed n1, an operating malfunction is present if the vibration characteristic value S exceeds a relatively small limit value S_{MAX1}.

A second characteristic curve 27, on the other hand, shows the increasing unbalance U at a relatively high speed n2. Here, an operating malfunction is present when the vibration characteristic value S exceeds a larger limit value S_{MAX2}.

The different curves 26, 27 shown do not necessarily have to be due to the higher or lower speed. The cause can also be, for example, the frequency-dependent transmission behavior of the robot arm, or other reasons.

In the text and in FIG. 5 it is described that the rotational speed n1 is relatively low and the rotational speed n2 is relatively high, and that for the low rotational speed n1 a relatively small limit value is used, and for the high rotational speed n2 a larger limit value is used. However, this is only to be understood as a possible example. In general, the following applies: Even if the higher speed results in a higher excitation force (due to the unbalance), this does not necessarily lead to higher vibration intensities at the measuring point. For example, not if the vibration transmission from the excitation to the measuring point is correspondingly “worse” for the higher speed (higher frequency) than for the lower speed (lower frequency). Or expressed differently: higher vibration intensities can also occur at the measuring point at a lower rotational speed than at a higher rotational speed (i.e. just the other way around as shown/described). Then, for example, a higher limit value would be used for the lower speed than for the higher speed.

The decisive general statement is therefore that at different speeds n1 and n2, different vibration intensities (or curves) are generally to be expected at the measuring point. Accordingly, the limit value must “fit” the speed.

For example, measurements/evaluations at two (significantly) different speeds would also be a kind of redundant monitoring.

FIG. 6 shows a vibration diagram in the area of a collision of the painting robot with a room boundary (e.g. cabin wall of a painting cabin). At time t=t1, the collision occurs, which manifests itself in two different vibration events 28, 29.

At time t=t1 of the collision, the vibration event 28 occurs first, which manifests itself in the fact that the vibrations exceed a predefined limit value A_{MAX}. According to a further example, however, the vibration event can also be expressed by the fact that the vibrations fall below a predefined limit value.

The other vibration event 29 occurs after the actual collision and manifests itself in the fact that the vibration behavior is subsequently changed and increased in the specific embodiment.

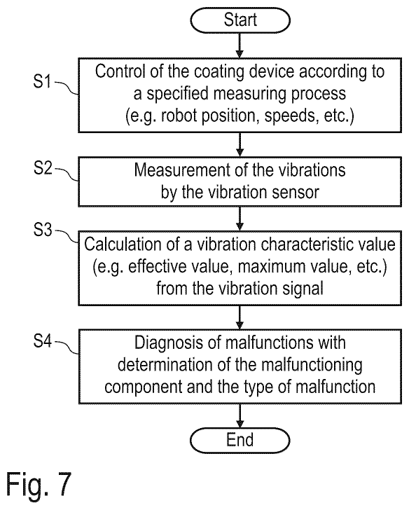

FIG. 7 shows a flow chart illustrating the operating method according to the disclosure.

In a first step S1, the coating device is controlled according to a predetermined measuring process. Here, for example, the robot position of the coating robot can be predetermined. Furthermore, it is possible that the measuring process provides for certain rotational speeds of the rotary atomizer. Alternatively, it is also possible for certain parts of the coating device to be in operation during the measuring process, while other parts of the coating device are out of operation. Furthermore, the measuring process can also provide that only a certain robot axis is moved when the rotary atomizer is not rotating, in order to be able to determine motor and/or gearbox damage, for example, as part of the measuring process.

During the measurement process, the vibrations are then measured by the vibration sensor in a step S2.

In a step S3, a vibration characteristic value is then calculated from the vibration signal.

In a step S4, a diagnosis of operational malfunctions is then performed with a determination of the disturbed component and also with a determination of the type of malfunction.

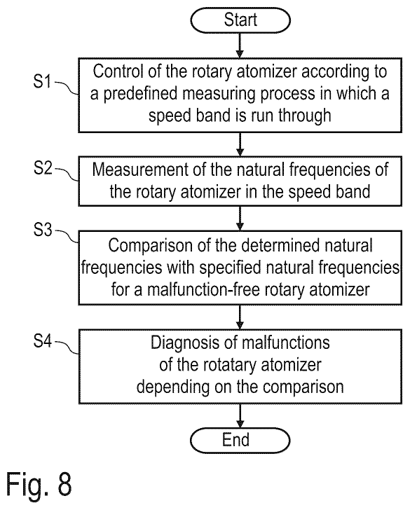

FIG. 8 shows a variation of FIG. 7.

Here, too, a predefined measuring process is controlled in a step S1, whereby the rotary atomizer runs through a certain speed band in the measuring process.

In step S2, the natural frequencies of the rotary atomizer in the speed band are determined.

In a further step S3, the natural frequencies determined are then compared with predefined natural frequencies that would occur with a fault-free rotary atomizer.

In a step S7, possible operating malfunctions are then diagnosed depending on the comparison.

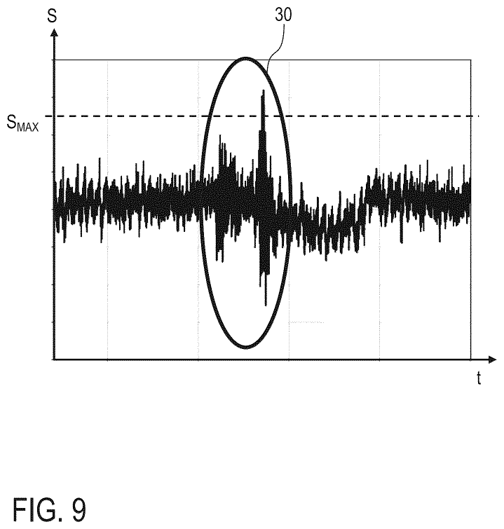

FIG. 9 shows a variation of the diagram in FIG. 6 to illustrate an oscillation event in a valve circuit of a valve. The valve can be any valve in a coating system, such as a paint valve, a solvent valve, a pulse air valve or a shaping air valve, to name just a few examples.

On the X-axis of the diagram the time t is plotted, while on the Y-axis a vibration characteristic value S is plotted, which is calculated from the recorded vibration signals.

For example, the vibration parameter S can be the rms value of the vibration signal, the maximum value of the vibration signal, the first order amplitude of the vibration signal, a higher order amplitude of the vibration signal, the distortion factor of the vibration signal or the crest factor of the vibration signal, to name just a few examples.

Furthermore, during a switching operation, the diagram shows an oscillation event 30 that causes the oscillation characteristic value S to exceed a predetermined maximum value S_{MAX}, indicating a malfunction of the valve.

Depending on reference measurements during switching operations of an intact valve, the malfunction of the valve may also be indicated by the absence of the oscillation event 30 or the failure to exceed the maximum value S_{MAX}.

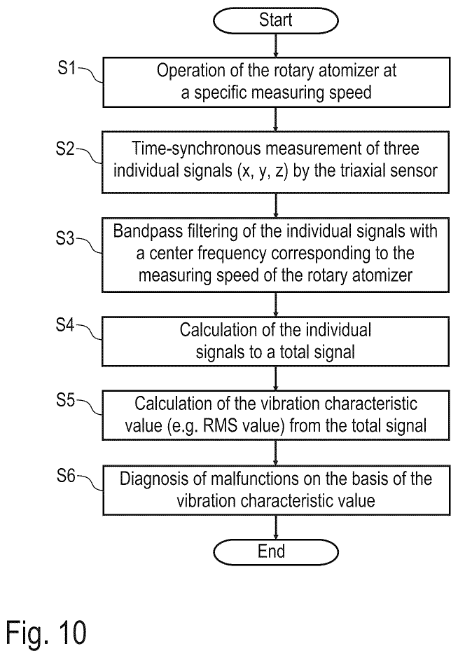

In the following, the flow chart according to FIG. 10 is described, which shows a variant of the operating method according to the disclosure.

In a first step S1, the rotary atomizer is controlled so that it rotates at a specific measuring speed. The measuring speed may optionally lie outside the resonance range or coincide with the resonance frequency. The rotary atomizer can therefore be controlled either to avoid resonance or to specifically aim for resonance.

In a second step S2, three individual signals are then measured in the three spatial directions (X, Y, Z) by a three-axis sensor. The individual signals are vibration signals in the three spatial directions (X, Y, Z).

The next step S3 then provides for the three individual signals to be bandpass filtered at a center frequency corresponding to the measurement speed of the rotary atomizer.

In the next step S4, the individual signals are processed to form an overall signal. For example, the temporal course of the vector magnitude (“length of the orbit arrow”) can be calculated from the three individual signals.

In the next step S5, a vibration characteristic value is calculated from the overall signal, for example the effective value.

In the last step S6, malfunctions are then diagnosed on the basis of the vibration characteristic value, as already described above.

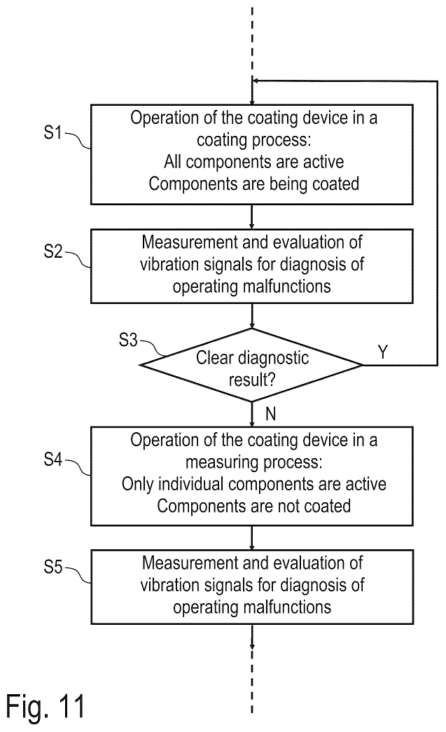

In the following, the flow chart according to FIG. 11 will now be described, which illustrates a variant of the operating method according to the disclosure.

In a first step S1, the coating device is operated in a normal coating process, i.e. all components (e.g. rotary atomizer, metering pump, motors, electrostatic coating agent charging system, etc.) are active and components are coated. The coating process is therefore the normal operation of the coating device for painting components.

During this normal coating process, a measurement and evaluation of the vibration signals is then carried out in a further step S2 for the diagnosis of operating malfunctions, as already described in detail above.

In a next step S3, it is then checked whether the evaluation of the vibration signals leads to an unambiguous diagnostic result. The unambiguous diagnostic result may be, for example, that no operating malfunction is detected. However, it is also possible that an operating malfunction is detected, but it can be clearly assigned at which component of the coating device the operating malfunction occurs and what type of operating malfunction it is. In this case, the operation of the coating device can be continued in the normal coating process or an error message is generated.

However, the case may arise in the normal coating process that no clear diagnostic result is detected. This may be due to the fact that the plurality of components of the coating device generate vibrations, so that in view of the plurality of different vibrations from different components, the operating malfunction cannot be isolated and identified. In such a case, step S4 switches from the coating process to a separate measurement process. In this measuring process not all components of the coating device are actively operated, but only individual components or even only a single component.

In a further step S5 then again the vibration signals are measured and evaluated, in order to identify the operational malfunction.

In the measurement process, the identification of the operating malfunctions is easier because only a few components are active and correspondingly few vibration signals occur, so that the signal evaluation is much easier.

After identifying the operating malfunctions, it is then possible to switch back to the coating process, which is not shown here for simplicity.

The disclosure is not limited to the preferred embodiments described above. Rather, a large number of variants and variations are possible which also make use of the inventive concept and therefore fall within the scope of protection. In particular, the disclosure also claims protection for the subject-matter and the features of the dependent claims independently of the claims referred to in each case and in particular also without the features of the main claim. Thus, the disclosure is not limited to such variants of the disclosure in which the evaluation unit distinguishes different operating malfunctions from one another and can also diagnose different components that are susceptible to malfunctions. Thus, the disclosure also claims protection for the other aspects of the disclosure independently of the technical teaching of the main claim.

1.-19. (canceled)

20. A Coating device for coating components with a coating agent, comprising
a) a plurality of components which are susceptible to malfunctions and in which operating malfunctions can occur during operation of the coating device,
b) at least one vibration sensor for detecting mechanical vibrations in the coating device and for converting them into a vibration signal which can be evaluated in terms of control technology in accordance with the detected mechanical vibrations, and
c) an evaluation unit for evaluating the vibration signal from the at least one vibration sensor and for diagnosing an operating malfunction in one of the components of the coating device which are subject to malfunctions as a function of the vibration signal,
d) wherein the evaluation unit diagnoses various operating malfunctions of various components of the coating device that are susceptible to malfunctions by evaluating the vibration signal of the vibration sensor.

21. The coating device according to claim 20, wherein the coating device comprises a painting robot for painting motor vehicle body components with a paint.

22. The coating device according to claim 20, wherein the malfunction-prone components of the coating device monitored for the operating malfunctions comprise one or more of the following components:
a) a coating robot with several robot axes, said coating robot comprising:
a1) a robot base, which is optionally stationary or movable,
a2) a pivotable robot member which is pivotable relative to the robot base,
a3) a proximal robot arm which is pivotable relative to the pivotable robot member,
a4) a distal robot arm pivotable relative to the proximal robot arm, and/or
a5) a robot hand axis mounted on the distal robot arm,
b) an application device for applying the coating agent, wherein the application device is a rotary atomizer with a rotatable bell cup, wherein the application device is guided by the coating robot,
c) a compressed air turbine in the application device for driving a rotatable turbine shaft of the rotary atomizer,
d) a bell cup mounted on the turbine shaft of the rotary atomizer,
e) a metering pump for metering the coating agent to the application device,
f) at least one electric motor for driving one of the robot axes of the coating robot,
g) at least one gearbox driven by one of the motors and acting on one of the robot axes,
h) at least one bearing,
i) an electrically or pneumatically controllable valve, wherein the valve is selected from a group consisting of:
i1) a coating agent valve for controlling a coating agent flow,
i2) a rinsing agent valve for controlling a flow of rinsing agent,
i3) a valve for controlling an air flow,
i4) a valve for opening/closing a disposal section through which alternately or mixed coating, rinsing/solvent and/or compressed air flows.

23. The coating device according to claim 22, wherein
a) the vibration sensor is mounted on the coating robot remote from the application device, in particular on the robot base, on the pivotable robot member, on the proximal robot arm, on the distal robot arm or on the robot hand axis,
b) the mechanical vibrations emanating from the application device are transmitted via the coating robot to the vibration sensor, the coating robot having certain vibration transmission properties, and
c) the evaluation unit determines operating malfunctions of the application device by evaluating the vibration signal and taking into account the vibration transmission properties of the coating robot.

24. The coating device according to claim 22, wherein the evaluation unit diagnoses and distinguishes from each other several of the following operating malfunctions of the coating device by an evaluation of the vibration signal of the vibration sensor:
a) unbalance of a bell cup of a rotary atomizer,
b) unbalance of a component rotating with the bell cup,
c) mechanical wear of a bearing,
d) oil loss or missing gear oil at a gearbox,
e) oil loss or missing motor oil on a motor,
f) assembly errors,
g) faulty drive shaft of a metering pump,
h) collision of the coating robot with an obstacle,
i) faulty valve circuit and/or faulty function of a valve,
j) gearbox damage,
k) motor damage.

25. The coating device according to claim 20, wherein
a) the vibration sensor is a biaxial or triaxial acceleration sensor, or
b) the acceleration sensor comprises a biaxial or triaxial acceleration sensor and a biaxial or triaxial gyroscope.

26. The coating device according to claim 20, wherein
a) the coating device comprises an explosion-proof chamber, and
b) the vibration sensor is arranged in the explosion-proof chamber.

27. The coating device according to claim 20, wherein
a) the coating device comprises a coating robot with at least six robot axes which are arranged kinematically in series one behind the other,
b) the individual robot axes each have an axis drive with a housing,
c) the vibration sensor is arranged in the housing of the axis drive for the fourth, fifth or sixth robot axis.

28. The coating device according to claim 20, wherein
a) the coating device comprises an electrostatic coating agent charging system and therefore comprises a high-voltage area and an electrically grounded area, and
b) the vibration sensor is arranged in the electrically grounded area.

29. The coating device according to claim 20, wherein the evaluation unit calculates and evaluates at least one of the following vibration characteristic values from the vibration signal:
a) RMS value of the vibration signal,
b) maximum value of the vibration signal,
c) 1st order amplitude of the vibration signal,
d) higher order amplitude of the vibration signal,
e) distortion factor of the vibration signal,
f) crest factor of the vibration signal.

30. The coating device according to claim 29, wherein the at least one vibration characteristic value is calculated from the vibration signal by sensor electronics which are structurally integrated into the vibration sensor.

31. The coating device according to claim 29, wherein the at least one vibration characteristic value is calculated from the vibration signal by the evaluation unit, the evaluation unit being structurally separate from the vibration sensor.

32. The coating device according to claim 29, wherein the at least one vibration characteristic value is calculated by software which runs in a microprocessor which is connected to the evaluation unit.

33. The coating device according to claim 29, wherein
a) the evaluation unit compares the at least one vibration characteristic value with a limit value,
b) the evaluation unit generates a first warning signal if the at least one vibration characteristic value exceeds or falls below the limit value,
c) preferably the first warning signal is indicated optically and/or acoustically to the operator of the coating device.

34. The coating device according to claim 29, wherein
a) the evaluation unit monitors the vibration characteristic value over the operating period of the coating device,
b) the evaluation unit compares the vibration characteristic value with a predetermined component-specific aging behavior, and
c) the evaluation unit generates a second warning signal if the comparison of the vibration characteristic value with the predetermined aging behavior indicates that, due to wear, maintenance or replacement of one of the malfunction-prone components is required.

35. The coating device according to claim 34, wherein the first and/or the second warning signal is a maintenance signal.

36. The coating device according to claim 34, wherein the first and/or the second warning signal is a stop signal.

37. The coating device according to claim 20, wherein
a) a control unit is provided which controls the coating device for vibration measurement according to a predetermined measurement process,
b) the at least one vibration sensor measures the vibrations in the coating device during the measuring process, and
c) the evaluation unit evaluates the vibration signals detected during the measuring process.

38. The coating device according to claim 37, wherein
a) the control unit controls the coating robot into a specific robot position for vibration measurement during the measurement process, and
b) the control unit controls the coating robot for vibration measurement during the measuring process according to a predetermined movement pattern.

39. The coating device according to claim 37, wherein the control unit controls the rotary atomizer for vibration measurement during the measuring process at a specific rotational speed which is not in the range of resonance frequencies.

40. The coating device according to claim 37, wherein the control unit controls the rotary atomizer for vibration measurement during the measurement process successively at increasing rotational speeds, with vibration measurement taking place in each case at the individual rotational speeds.

41. The coating device according to claim 37, wherein
a) the control unit controls the rotary atomizer during the measuring process at different speeds which run through a speed band,
b) the evaluation unit determines actual values of natural frequencies of the component susceptible to malfunction within the speed band during the measuring process by evaluating the vibration signal, and
c) the evaluation unit compares the actual values of the natural frequencies with predetermined desired values of the natural frequencies in order to detect an operating malfunction.

42. The coating device according to claim 37, wherein
a) the control unit controls the coating device according to a coating process in which several or all components of the coating device are active and the coating device coats the components with the coating agent,
b) the at least one vibration sensor measures the vibrations in the coating device during the coating process, and
c) the evaluation unit evaluates the vibration signals detected during the coating process in order to identify operating malfunctions.

43. The coating device according to claim 42, wherein
a) not all components of the coating device are active in the measuring process, or only a single component of the coating device is active, and
b) the control unit only activates the measuring process if the operating malfunction could not be clearly identified in the coating process.

44. The coating device according to claim 20, wherein the at least one vibration sensor is the only vibration sensor of the coating device.
